(19) United States
(12) Patent Application Publication
(10) Pub. No.: US 2011/0244878 A1
(43) Pub. Date: Oct. 6, 2011

(54) Identifying and Displaying User Status Information

(75) Inventors: Vladimir Kochetkov, Saint Petersburg (RU); Evgeny Yuzhakov, Saint Petersburg (RU)

(73) Assignee: Seconca Holdings Limited, Larnaca (CY)

(21) Appl. No.: 12/755,349

(22) Filed: Apr. 6, 2010

(51) Int. Cl. H04W 40/00; H04W 64/00

(52) U.S. Cl. 455/456.1; 455/422.1

(57) ABSTRACT

A method identifies multiple contacts associated with a user, where the user and the multiple contacts are associated with a common mobile service. A relationship is defined between the user and each of the multiple contacts by the common mobile service. Each of the multiple contacts is monitored automatically by the common mobile service to obtain user information. A mobile device associated with the user displays the current user information associated with at least a portion of the multiple contacts.

### BACKGROUND

The use of mobile devices, such as cell phones, smart phones, and the like is growing at a fast pace. Users of mobile devices communicate via voice conversations, text messages, instant messages, email messages, and so forth. As the usage of mobile devices increases, users are seeking new ways to communicate with friends, family members, and co-workers in an efficient manner.

Existing mobile devices support contact lists (also referred to as “address books”) of people that are contacted by the user on a regular basis. These contact lists identify multiple individuals or entities that the user frequently calls, emails, sends text messages, or otherwise communicates. Contact lists simplify the initiation of calls, emails, text messages and other communications by allowing the user to identify a particular contact from the list and initiate communication by activating a few buttons on the mobile device. However, existing mobile devices do not support the automatic identification and display of status information associated with one or more individuals in the contact list. Such status information would benefit a user by allowing the user to determine an appropriate time to contact a particular individual in the contact list.

It is therefore desirable to provide an improved system and method for automatically identifying and displaying an individual's status information on a mobile device.

### BRIEF DESCRIPTION OF THE DRAWINGS

Similar reference numbers are used throughout the figures to reference like components and/or features.

FIG. 1 is a block diagram illustrating an example environment capable of implementing the systems and methods discussed herein.

FIG. 2 is a block diagram illustrating various components of a mobile service.

FIG. 3 is a flow diagram illustrating an embodiment of a procedure for obtaining information associated with a user's friends.

FIG. 4 is a flow diagram illustrating an embodiment of a procedure for automatically identifying a status associated with one or more friends.

FIG. 5 is a flow diagram illustrating an embodiment of a procedure for displaying information associated with one or more friends.

FIG. 6 is a flow diagram illustrating an embodiment of a procedure for automatically exchanging data between two users.

FIG. 7A illustrates an example user interface on a mobile device displaying the status of multiple friends.

FIG. 7B illustrates an example user interface on a mobile device displaying information associated with a particular friend.

FIG. 7C illustrates an example user interface on a mobile device displaying the approximate geographic location of multiple friends.

### DETAILED DESCRIPTION

The systems and methods described herein provide systems and methods for identifying and displaying user status information. The described systems and methods are capable of automatically identifying individuals and entities in a user's contact list that use a common mobile service. For those identified individuals and entities, the user's mobile device can display various location information, status information, and other data related to one or more individuals or entities.

As used herein, the term “mobile device” refers to any mobile (or portable) device capable of communicating with other devices via one or more wireless communication links. Example mobile devices include cellular phones, smart phones, personal digital assistants (PDAs), laptop computers, handheld computers, tablet computers, portable media devices, handheld gaming devices, and any other portable communication device.

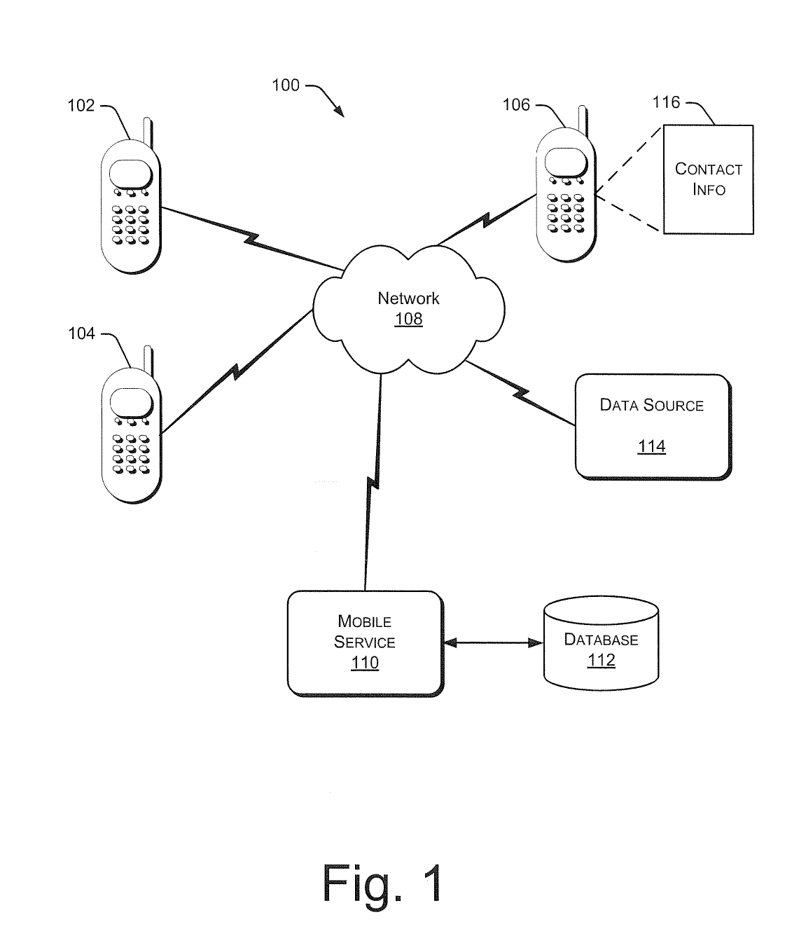

FIG. 1 is a block diagram illustrating an example environment 100 capable of implementing the systems and methods discussed herein. Environment 100 includes mobile devices 102, 104 and 106 (shown as cellular phones in this example). Mobile devices 102, 104 and 106 communicate with other mobile devices via a network 108, which is implemented using any wireless communication mechanism and any communication protocol. In a particular embodiment, network 108 is a combination of multiple wireless communication links between any number of devices. Embodiments of network 108 include mobile networks, cellular networks, wifi networks, and the like.

Certain implementations of network 108 may include a public switched telephone network (PSTN) combined with one or more wireless communication links or networks. Network 108 is capable of communicating any type of information, such as voice communications, text data, graphics data, and so forth.

Environment 100 also includes a mobile service 110 that provides any number of services and features for mobile device users. In particular embodiments, mobile service 110 is a cellular phone service provider that also provides one or more of the features discussed herein. In other embodiments, mobile service 110 is an extension of an existing cellular phone service that provides additional features as described herein.

Mobile service 110 is coupled to a database 112 that stores various information, such as user information, contact lists, settings, preferences, and other data used during the operation of mobile service 110. Additional details regarding the operation of mobile service 110 are provided below.

As shown in FIG. 1, environment 100 includes a data source 114 that is accessible by mobile devices 102, 104, 106 and mobile service 110 via network 108. Data source 114 includes any type of data, such as user information, event information, geographic information (e.g., maps), and so forth. In certain embodiments, the information accessible from data source 114 is used by mobile service 110 to provide the features described herein. Mobile devices 102, 104, 106 maintain various contact information 116 associated with friends, family members, and other individuals or entities that have a relationship with the user of the mobile device. Contact information 116 includes, for example, names, phone numbers, email addresses, physical addresses, text addresses, photographs, birthdays, and other information. A typical mobile device 102, 104, 106 contains contact information for multiple individuals and entities. As discussed herein, contact information 116 is useful in identifying and displaying user status information. A particular implementation of environment 100 may include any number of mobile devices 102, 104, 106, any number of mobile services 110, and any number of data sources 114.

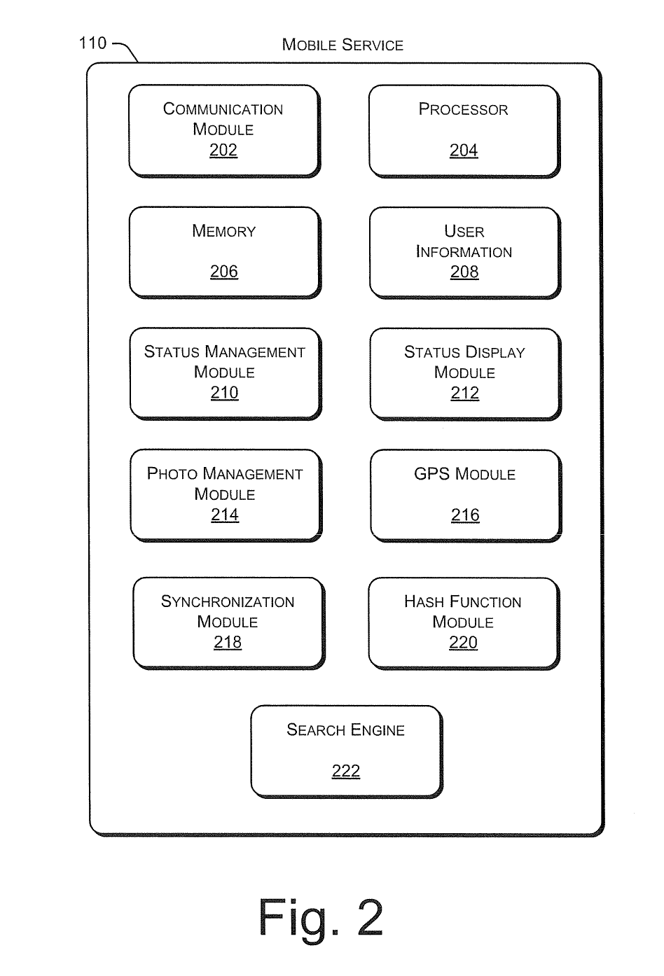

FIG. 2 is a block diagram illustrating various components of mobile service 110, which includes a communication module 202, a processor 204, and a memory 206. Communication module 202 allows mobile service 110 to communicate with other devices and systems, such as mobile devices 102, 104, 106 shown in FIG. 1. Processor 204 executes various instructions to implement the functionality provided by mobile service 110. Memory 206 stores these instructions as well as other data used by processor 204 and other modules contained in mobile service 110.

Mobile service 110 also includes user information 208, such as user name, profile information, contact list, and so forth. A status management module 210 maintains status information with any number of contacts in a user's contact list. This status information may include a contact's geographic location, the contact's mobile device status (e.g., “On”, “Off” or “Busy”), the contact's availability status (e.g., “available”, “unavailable” or “Do Not Disturb”), and the like. A status display module 212 generates data necessary to display status information associated with one or more individuals on any number of mobile devices.

A photo management module 214 in mobile service 110 manages user photographs, avatars, and other video information used in displaying status information and other data on a mobile device. A GPS module 216 manages maps and other GPS-related information to allow a mobile device to display GPS data as well as the location of one or more individuals disposed on the display of GPS data. A synchronization module 218 synchronizes user data and other information between mobile service 110 and multiple mobile devices. A hash function module 220 encodes and decodes hash values (also referred to as “hash codes”) communicated to and from multiple devices. Hash values are used to protect the security of the underlying data (i.e., the data associated with the hash value). By using hash values instead of the actual data, the actual data is not exposed during communication between mobile service 110 and the mobile devices. A search engine 222 identifies additional user information based on known information such as name, phone number, email address, and so forth. For example, if a user identifies a friend as having a specific phone number, search engine 222 can locate that friend's system identifier (in mobile service 110), name, and other information maintained by the mobile service.

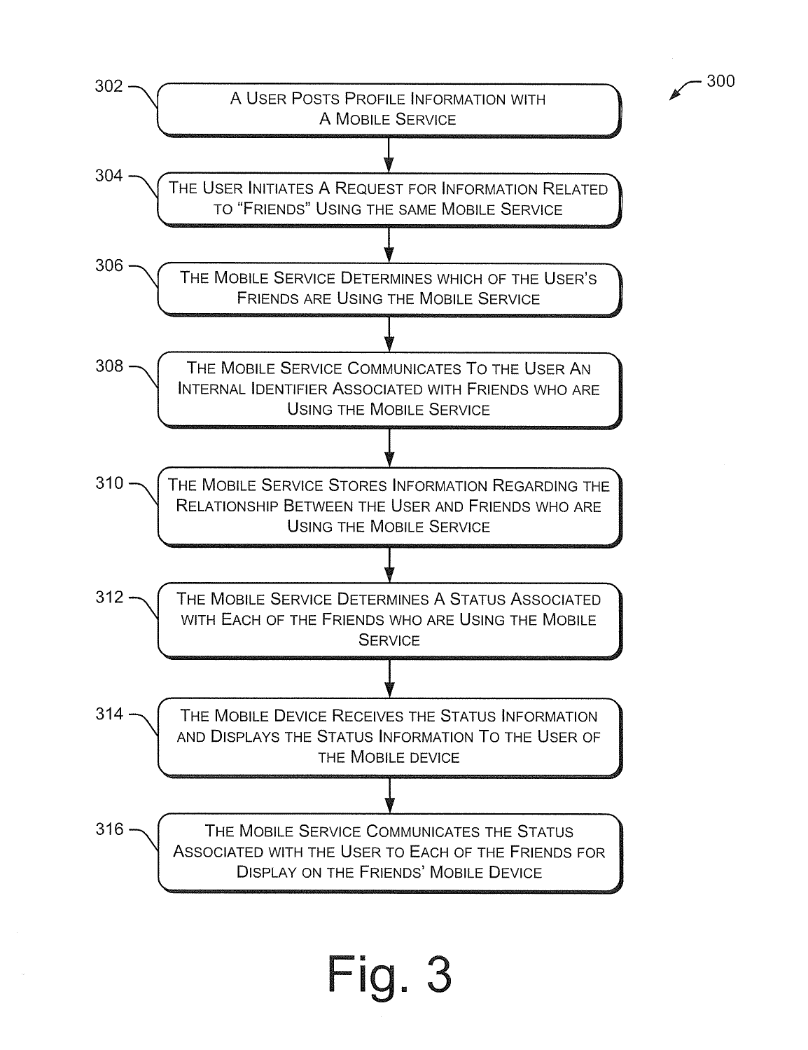

FIG. 3 is a flow diagram illustrating an embodiment of a procedure 300 for obtaining information associated with a user's friends, such as entries in the user's contact list. Initially, a user posts profile information with a mobile service (block 302), and initiates a request for information related to their friends using the same mobile service (block 304). The mobile service receives the request and determines which of the user's friends are using the mobile service (block 306). This determination can be performed, for example, by identifying a mobile service user having the appropriate phone number or other identifying information.

The mobile service then identifies an internal identifier associated with friends who are using the mobile service and communicates that internal identifier to the user's mobile device (block 308). The mobile service stores information regarding the relationship between the user and friends who are using the mobile service (block 310). The mobile service also determines a status associated with each of the friends who are using the mobile service (block 312), and communicates the status information to the appropriate mobile device. The mobile device receives the status information from the mobile service and displays the status information to the user of the mobile device (block 314). The mobile device may also display other information regarding the displayed friend, such as a photograph, nickname, and the like. The mobile service then communicates the status associated with the user to one or more friends of the user for display on the friends' mobile device (block 316).

The procedure of FIG. 3 can be initiated manually by a user or can be configured to occur automatically, such that the procedure is transparent to the users of the mobile service. In a particular embodiment, user data or contact information communicated between a mobile device and the mobile service is sent as a hash value. A hash value is a mathematical function that converts a large amount of data into a smaller data element. A hash value also provides security for the original data because the original data cannot be easily determined from the hash value without knowledge of the hash function (e.g., algorithm) used to generate the hash value.

In one embodiment, the user's friend information (e.g., contact list) is not stored by the mobile service. Instead, the mobile service uses the friend information to identify friends of the user that also use the mobile service. The mobile service notes that relationship, but does not store the friend's information. In other embodiments, the mobile service stores the friend information as a backup for the user. In this embodiment, if the user loses the contact information stored in their mobile device, the contact information can be restored from the mobile service.

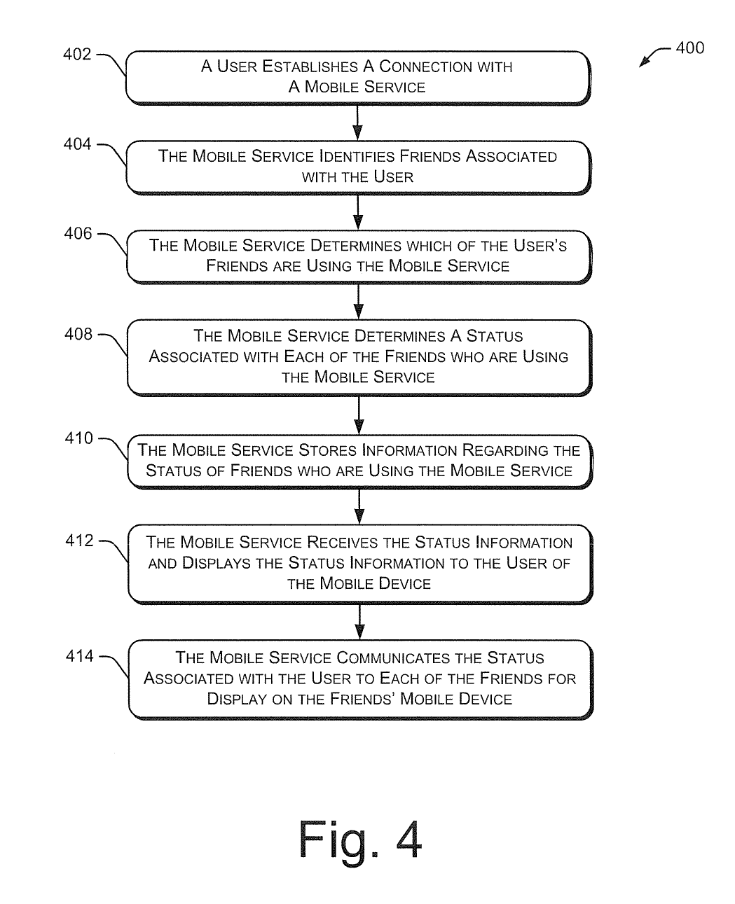

FIG. 4 is a flow diagram illustrating an embodiment of a procedure 400 for automatically identifying a status associated with one or more friends. Initially, a user establishes a connection with a mobile service (block 402), and the mobile service identifies friends associated with the user (block 404). The mobile service then determines which of the user's friends are using the mobile service (block 406). For those friends that are using the mobile service, the mobile service determines a status associated with each of the friends (block 408) and stores that status information for future reference (block 410). The mobile device then receives the status information and displays the status information to the user of the mobile device (block 412). Finally, the mobile device communicates the status associated with the user to each of the friends for display on the friends' mobile device (block 414). In a particular embodiment, after the user establishes a connection with the mobile service, the remaining portions of procedure 400 are performed automatically by the mobile service (e.g., transparent to the user).

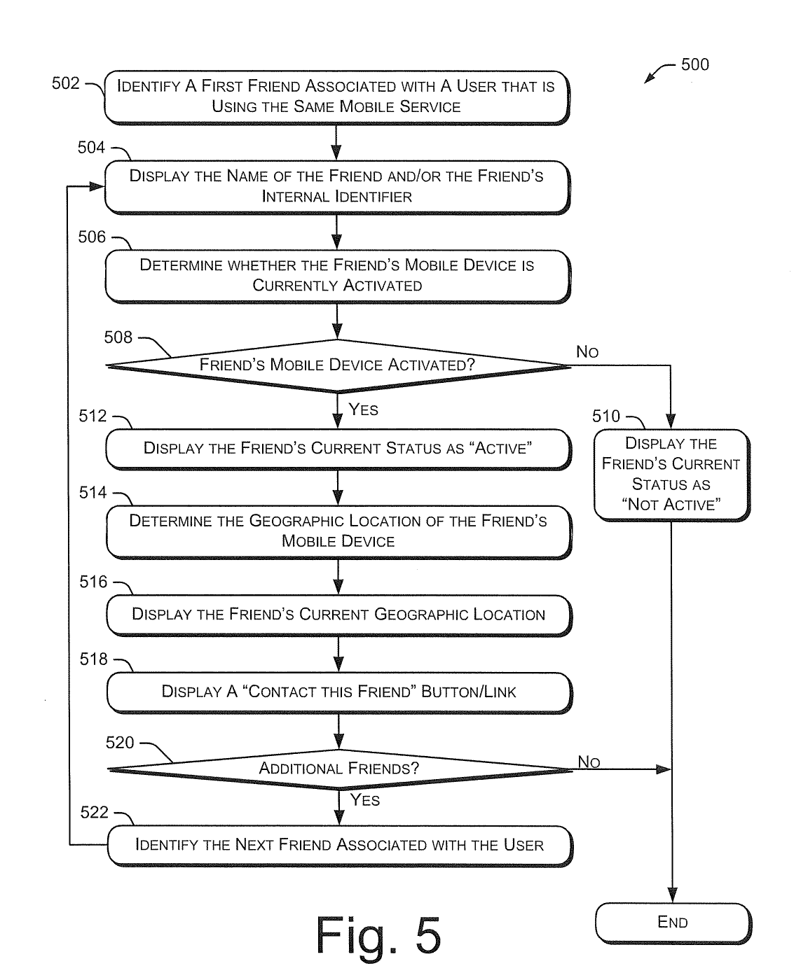

FIG. 5 is a flow diagram illustrating an embodiment of a procedure 500 for displaying information associated with one or more friends. Initially, the procedure identifies a first friend associated with a user that is using the same mobile service (block 502), and displays the name of the friend and/or the friend's internal identifier or nickname (block 504). Procedure 500 then determines whether the friend's mobile device is currently activated (block 506). If the friend's mobile device is not activated, the procedure branches to block 510 to display the friend's current status as “not active” (block 510).

If, at block 508, the friend's mobile device is activated, the procedure displays the friend's current status as “active” (block 512). Procedure 500 continues by determining the geographic location of the friend's mobile device (block 514) and displays the friend's current geographic location on the mobile device (block 516). Next, the procedure displays a “contact this friend” button or link on the mobile device (block 518). If there are additional friends in the user's contact list, the procedure identifies the next friend associated with the user and returns to block 504 to display the name of the friend. If there are no additional friends in the user's contact list, the procedure ends.

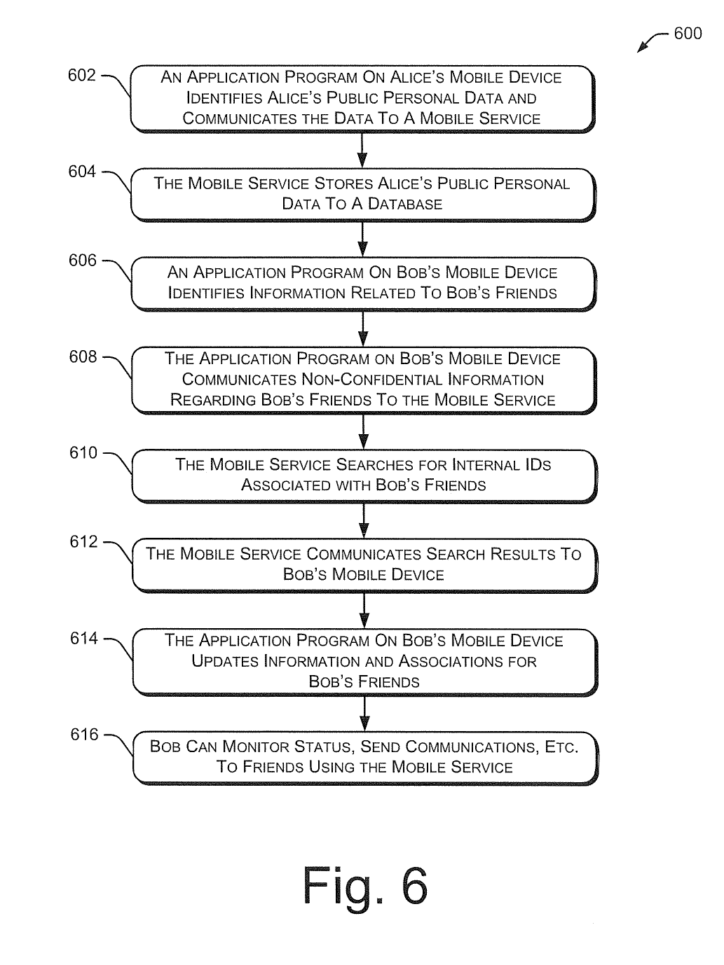

FIG. 6 is a flow diagram illustrating an embodiment of a procedure 600 for automatically exchanging data between two users—named Alice and Bob in this example. Initially, an application program on Alice's mobile device identifies Alice's public personal data (e.g., her mobile phone number) and communicates that data to a mobile service (block 602). The mobile service stores Alice's public personal data to a database (block 604). An application program on Bob's mobile device identifies information related to Bob's friends (block 606) and communicates non-confidential information regarding Bob's friends to the mobile service (block 608). In this example, Alice is one of Bob's friends. The mobile service then searches for internal identifiers associated with Bob's friends (block 610). Bob's friends will have associated internal identifiers in the mobile service if they are users (e.g., subscribers) of the mobile service. The results of the search for internal identifiers associated with Bob's friends are communicated to Bob's mobile device (block 612).

The application program on Bob's mobile device updates information and associations for Bob's friends (block 614) based on information received from the mobile service. Since Alice is one of Bob's friends, and Alice uses the same mobile service, Bob can now monitor the status of Alice, easily send her communications, monitor Alice's geographic location, and so forth using the mobile service (block 616).

In a particular embodiment, procedure 600 is performed automatically by the mobile service and the application program executing on Bob's mobile device (e.g., the procedure is performed transparently to Alice and Bob).

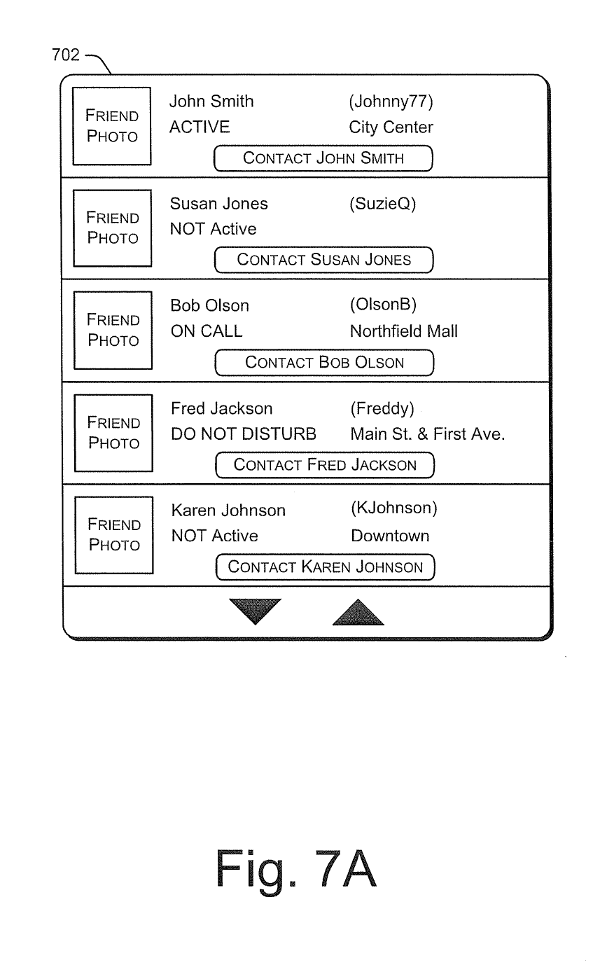

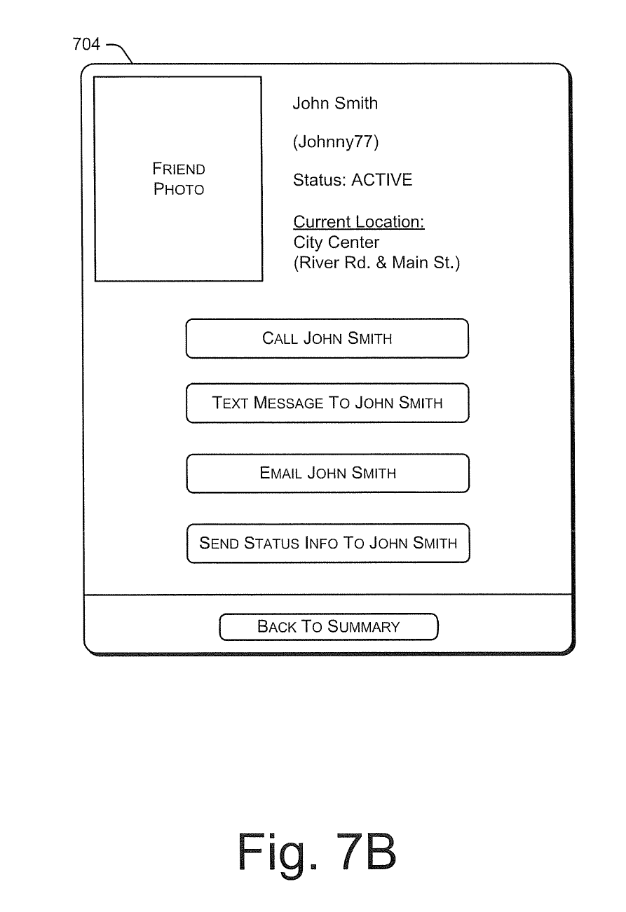

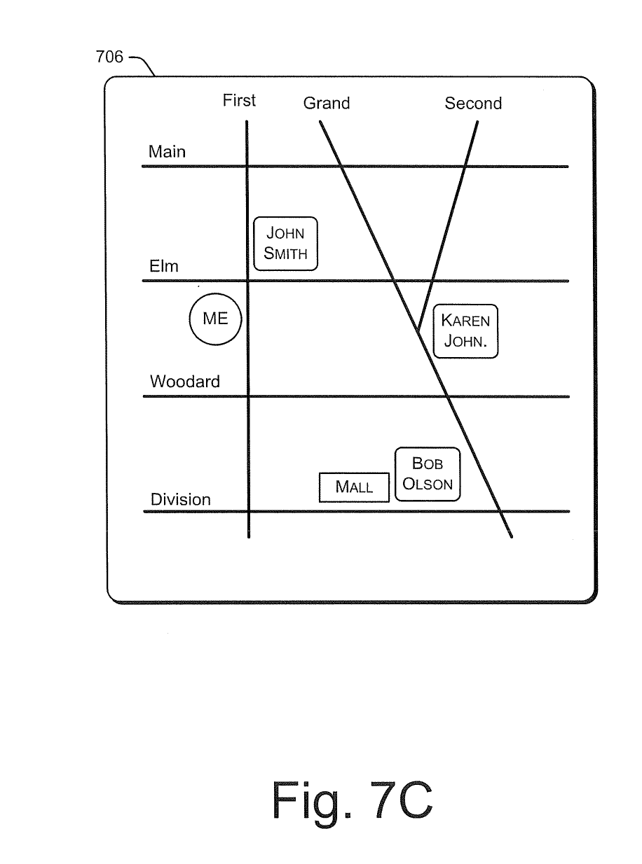

FIG. 7A illustrates an example user interface 702 on a mobile device displaying the status of multiple friends. User interface 702 displays status information for five friends (John Smith, Susan Jones, Bob Olson, Fred Jackson and Karen Johnson), as well as a photograph of each friend and a “contact” button for each friend. Additional information displayed about the friends includes a nickname (e.g., Johnny77 and SuzieQ), a current status of the friend (Active, Not Active, On Call and Do Not Disturb), and a current geographic location (City Center, Northfield Mall, Main St. & First Ave, and Downtown). User interface 702 also includes scroll buttons at the bottom of the interface to scroll through the list of friends.

When a user of the mobile device displaying user interface 702 activates one of the “contact” buttons associated with a friend, the user interface changes to display information associated with the particular friend, such as the user interface shown in FIG. 7B.

FIG. 7B illustrates an example user interface 704 on a mobile device displaying information associated with a particular friend. User interface 704 displays information about the friend as well as buttons that initiate a call to the friend, generate a text message, email the friend, or send status information to the friend (e.g., the user of the mobile device sends their current status information to the friend displayed in user interface 704. The user interface shown in FIG. 7B also includes a “Back to Summary” button that changes the user interface back to a summary list of the type shown in FIG. 7A.

FIG. 7C illustrates an example user interface 706 on a mobile device displaying the approximate geographic location of multiple friends. In this example, user interface 706 shows the approximate geographic location of three friends (John Smith, Karen Johnson, and Bob Olson). Additionally, user interface 706 displays the approximate geographic location of the user of the mobile device. As the user of the mobile device or any of the friends move geographically, their corresponding position is changed in user interface 706. Additionally, if a new friend activates their mobile device or comes in range of the map displayed on user interface 706, that friend's approximate geographic location will be displayed on the user interface.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate the identification and display of information associated with one or more users. Additionally, some embodiments are used in conjunction with one or more conventional mobile services, mobile devices, or other information display systems and methods. For example, one embodiment is used as an improvement of existing mobile services and mobile devices.

Although the components and modules illustrated herein are shown and described in a particular arrangement, the arrangement of components and modules may be altered to identify, retrieve, and display information in a different manner. In other embodiments, one or more additional components or modules may be added to the described systems, and one or more components or modules may be removed from the described systems. Alternate embodiments may combine two or more of the described components or modules into a single component or module.

Although specific embodiments of the invention have been described and illustrated, the invention is not to be limited to the specific forms or arrangements of parts so described and illustrated. The scope of the invention is to be defined by the claims appended hereto and their equivalents.

1. A method comprising:
identifying a plurality of contacts associated with a user, wherein the user and the plurality of contacts are associated with a common mobile service;
defining a relationship between the user and each of the plurality of contacts by the common mobile service;
monitoring each of the plurality of contacts automatically by the common mobile service to obtain current user information; and
displaying the current user information associated with at least a portion of the plurality of contacts on a mobile device associated with the user.

2. A method as recited in claim 1 wherein the current user information includes an identification of whether the particular contact is available to communicate via the mobile service.

3. A method as recited in claim 1 further comprising displaying a geographic location associated with at least a portion of the plurality of contacts on the mobile device associated with the user.

4. A method as recited in claim 1 further comprising displaying an alternate identifier associated with at least a portion of the plurality of contacts on the mobile device associated with the user.

5. A method as recited in claim 1 wherein displaying the current user information includes displaying an option to communicate with each of the displayed contacts.

6. A method as recited in claim 1 wherein monitoring each of the plurality of contacts includes communicating a contact identifier associated with each of the plurality of contacts to the mobile service.

7. A method as recited in claim 1 wherein monitoring each of the plurality of contacts includes:
calculating a hash code for a contact identifier associated with each of the plurality of contacts; and
communicating the hash code for each contact identifier to the mobile service.

8. A method as recited in claim 1 wherein monitoring each of the plurality of contacts includes:
communicating a contact identifier associated with each of the plurality of contacts to the mobile service; and
receiving status information associated with each of the plurality of contacts from the mobile service.

9. A method comprising:
establishing communication between a user and a mobile service;
identifying a plurality of friends associated with the user and associated with the mobile service;
determining a status associated with each of the identified friends;
communicating the status associated with at least one of the identified friends to the user; and
communicating a status associated with the user to at least one of the identified friends.

10. A method as recited in claim 9 wherein communicating the status associated with at least one of the identified friends to the user includes communicating a hash code associated with the status.

11. A method as recited in claim 9 wherein data communicated between the mobile service and the user is communicated in the form of a hash code.

12. A method as recited in claim 9 further comprising determining an approximate geographic location associated with each of the identified friends.

13. A method as recited in claim 9 further comprising displaying the status associated with at least one of the identified friends.

14. A method comprising:
establishing communication between a user and a mobile service;
identifying a plurality of friends associated with the user and associated with the mobile service;
determining a current information associated with each of the identified friends;
calculating a first hash code for an identifier associated with a particular friend;
communicating the first hash code to the user;
communicating the current information associated with the particular friend to the user;
calculating a second hash code associated with the current information associated with the user; and
communicating the second hash code to at least one of the identified friends.

15. A method as recited in claim 14 wherein the current information associated with the particular friend includes an identification of whether the particular friend is available to communicate via the mobile service.

16. A method as recited in claim 14 further comprising communicating an approximate geographic location of the particular friend to the user.

17. A method as recited in claim 14 further comprising communicating an approximate geographic location of the user to at least one of the identified friends.
